(19) United States
(12) Patent Application Publication
(10) Pub. No.: US 2026/0322984 A1
(43) Pub. Date: Oct. 15, 2026

(54) SYSTEM OF CONVERTING 2D IMAGE TO 3D IMAGE FOR STEREOSCOPIC DISPLAY AND METHOD THEREOF

(71) Applicant: LIGHT MATRIX INC., Taipei City (TW)

(72) Inventor: Wei-Ting CHEN, Taipei City (TW)

(21) Appl. No.: 19/260,511

(22) Filed: Jul. 6, 2025

(30) Foreign Application Priority Data
Apr. 14, 2025 (TW) 114114029

(51) Int. Cl. H04N 13/268; G06T 5/20; G06T 5/50; G06T 7/50; H04N 13/122; H04N 13/194; H04N 13/302

(52) U.S. Cl. CPC H04N 13/268; G06T 5/20; G06T 5/50; G06T 7/50; H04N 13/122; H04N 13/194; H04N 13/302; G06T 2207/10028; G06T 2207/20081

(57) ABSTRACT

A system of converting a 2D image to a 3D image for stereoscopic display and a method thereof are disclosed. In the system, a file conversion server performs an image enhancement computation on a depth map of a 2D target image to generate a depth-enhanced image, and generates a multi-view image matching a grating film property of a stereoscopic display device based on the depth-enhanced image, the stereoscopic display device downloads and displays the multi-view image, so that the stereoscopic display device can superimpose a grating with the multi-view image, display the display images in the multi-view image at different viewing angles to generate the stereoscopic image through an optical principle, thereby improving the display quality of the stereoscopic image and achieving the technical effect of displaying the stereoscopic image with high comfort and high resolution.

### CROSS-REFERENCE STATEMENT

The present application is based on, and claims priority from, TAIWAN Patent Application Serial Number 114114029, filed 2025-04-14, the disclosure of which is hereby incorporated by reference herein in its entirety.

### BACKGROUND OF THE INVENTION

### 1. Field of the Invention

The present invention relates to a stereoscopic image display system and a method thereof, and more particularly to a system of converting a 2D image to a 3D image for stereoscopic display and a method thereof.

### 2. Description of the Related Art

In recent years, the technology of image processing has continuously advanced, and it represents the continuous pursuit of more realistic visual experiences by humans. In addition, the general improvement of image and color processing technology, the processing of multi-view stereoscopic image further enhances the visual experience of three-dimensional space. For example, the entertainment industry, medical systems, and other places widely use stereoscopic image display technology.

However, to provide a comfortable stereoscopic image for viewers, the stereoscopic image needs to be displayed with a multi-view image. Unfortunately, the cost of multi-viewing angle cameras is high, making it difficult to see comfortable stereoscopic image displays. To solve the above problem, some companies use a depth image generation technology based on optical projection principles to generate 2D images with other viewing angles by performing preprocessing, 3D warping, and hole filling on the two-dimensional image with the depth map, and using the original 2D image and other 2D images with other viewing angle to generate a multi-view image that can provide stereoscopic display, thereby solving this problem.

However, due to the distortion of a 2D image with other viewing angle generated by the conventional depth image generation technology, the quality of the stereoscopic image displayed by the multi-view image generated by the depth image generation technology is not sufficient to meet the needs of people for comfortable viewing of stereoscopic images.

According to above-mentioned contents, what is needed is to develop an improved solution to solve the conventional problem of insufficient quality of three-dimensional display using the multi-view image generated by depth image generation technology.

### SUMMARY OF THE INVENTION

An objective of the present invention is to disclose a system of converting a 2D image to 3D for stereoscopic display and a method thereof, to solve the conventional problem of insufficient quality of three-dimensional display using the multi-view image generated by depth image generation technology.

To achieve the objective, the present invention disclose a system of converting a 2D image to a 3D image for stereoscopic display, and the system at least includes a front-end device, a file conversion server, and a stereoscopic display device. The front-end device is configured to select a target image, wherein the target image is a two-dimensional image. The file conversion server is configured to receive the target image transmitted by the front-end device, use a deep learning model to generate a depth map of the target image, and perform at least one image enhancement computation on the depth map to generate a depth-enhanced image, and generate a multi-view image matching a grating film based on the depth-enhanced image, wherein the multi-view image comprises display images, and viewing angles of the display images are different from each other. The stereoscopic display device includes a grating film having a grating, and the grating includes multiple grating units. The stereoscopic display device is configured to download the multi-view image generated by the file conversion server, and display the multi-view image, superimpose the grating with the multi-view image, and display the display images of the multi-view image corresponding to the different viewing angles through optical principle.

To achieve the objective, the present invention disclose a method of converting a 2D image to a 3D image for stereoscopic display, and the method at least include steps of: selecting a target image and transmitting the target image to a file conversion server, by a front-end device, wherein the target image is a two-dimensional image; using a deep learning model to generate a depth map of the target image, by the file conversion server; performing at least one image enhancement computation on the depth map to generate a depth-enhanced image, by the file conversion server; generating a multi-view image matching a grating film property of a stereoscopic display device based on the depth-enhanced image, by the file conversion server, wherein the multi-view image comprises multiple display images and viewing angles of the display images are different from each other; after the file conversion server generates the multi-view image, downloading the multi-view image, by the stereoscopic display device; displaying the multi-view image, superimposing a grating in a grating film with the multi-view image, and displaying the display images of the multi-view image corresponding to the different viewing angles through an optical principle, by the stereoscopic display device.

According to the system and method disclosed by the present invention, the difference between the present invention and the conventional technology in that, in the present invention, the file conversion server performs the image enhancement computation on the depth map of the 2D target image to generate the depth-enhanced image, and generates the multi-view image matching the grating film property of the stereoscopic display device based on the depth-enhanced image, the stereoscopic display device superimposes the grating with the multi-view image and displays the display images in the multi-view image at different viewing angles to generate the stereoscopic image through optical principles, thereby solving the conventional problem and achieving the technical effect of displaying the stereoscopic image with high comfort and high resolution.

### BRIEF DESCRIPTION OF THE DRAWINGS

The structure, operating principle and effects of the present invention will be described in detail by way of various embodiments which are illustrated in the accompanying drawings.

FIG. 1 is a schematic view of modules of a computing apparatus, according to the present invention.

FIG. 2 is a schematic view of modules of a system of converting a 2D image to a 3D image for stereoscopic display, according to the present invention.

FIG. 3A is a flowchart of a method of converting a 2D image to a 3D image for stereoscopic display, according to the present invention.

FIG. 3B is a flowchart of an image enhancement computation, according to the present invention.

FIG. 3C is a flowchart of downloading a multi-view image by the stereoscopic display device, according to the present invention.

FIG. 4 is a schematic view of a multi-view image with interleaved subpixels, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms "a", "an" and "the" are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term "or" includes any and all combinations of one or more of the associated listed items.

It will be acknowledged that when an element or layer is referred to as being "on," "connected to" or "coupled to" another element or layer, it can be directly on, connected or coupled to the other element or layer, or intervening elements or layers may be present. In contrast, when an element is referred to as being "directly on," "directly connected to" or "directly coupled to" another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

The present invention can convert the 2D target images into a multi-view image containing multiple display images with different viewing angles through a file conversion server, and display the target images in a three-dimensional manner by superimposing the displayed multi-view image with the grating of the stereoscopic display device.

The file conversion server and the stereoscopic display device of the present invention can be implemented by a computing apparatus. The computing apparatus mentioned in the present invention can include, but not limited to, one or more processing module, one or more memory module, and a bus connected to different hardware components including the memory module and the processing module. Through the multiple hardware components, the computing apparatus can load and execute the operating system, so that the operating system runs on the computing apparatus and executes software or programs. In addition, the computing apparatus can include an outer shell, and the above-mentioned hardware components are disposed in the outer shell.

The bus mentioned in the present invention can include at least one type of bus, for example, the bus can include at least one of a data bus, an address bus, a control bus, an expansion bus, and a local bus. The bus of a computation device can include, but not limited to, a parallel bus such as an industry standard architecture (ISA) bus, a peripheral component interconnect (PCI) bus, a video electronics standards association (VESA) local bus, or a serial bus such as a USB, or a PCI express (PCI-E/PCIe) bus.

The processing module of the computing apparatus is coupled with the bus. The processing module includes a register group or a register space. The register group or the register space can be completely set on the processing chip of the processing module, or can be all or partially set outside the processing chip and is coupled to the processing chip through dedicated electrical connection and/or a bus. The processing module can be a central processing unit, a microprocessor, or any suitable processing component. If the computing apparatus is a multi-processor apparatus, that is, the computing apparatus includes processing modules, and the processing modules can be all the same or similar, and coupled and communicated with each other through a bus. The processing module can interpret a computer instruction or a series of multiple computer instructions to perform specific operations or operations, such as mathematical operations, logical operations, data comparison, data copy/moving, so as to drive other hardware component, execute the operating system, or execute various programs and/or module in the computing apparatus. The computer instructions can include assembly language instructions, instruction set architecture instructions, machine instructions, machine-related instructions, microinstructions, firmware instructions, or source code or object code written in one or more programming languages. The instructions can be executed entirely on a single computing apparatus, partially on a single computing apparatus, or partially on one computing apparatus and partially on another interconnected computing apparatus. The above-mentioned programming language can be, for example, object-oriented languages such as Common Lisp, Python, C++, Objective-C, Smalltalk, Delphi, Java, Swift, C#, Perl, Ruby, as well as procedural languages like C or similar languages.

The computing apparatus usually also includes one or more chipsets. The processing module of the computing apparatus can be coupled to the chipset, or electrically connected to the chipset through the bus. The chipset includes one or more integrated circuits (IC) including a memory controller and a peripheral input/output (I/O) controller, that is, the memory controller and the peripheral input/output controller can be implemented by one integrated circuit, or implemented by two or more integrated circuits. Chipsets usually provide I/O and memory management functions, and multiple general-purpose and/or dedicated-purpose registers, timers. The above-mentioned general-purpose and/or dedicated-purpose registers and timers can be coupled to or electrically connected to one or more processing modules to the chipset for being accessed or used.

The processing module of the computing apparatus can also access the data stored in the memory module and mass storage area installed on the computing apparatus through the memory controller. The above-mentioned memory modules include any type of volatile memory and/or non-volatile memory (NVRAM), such as Static Random Access Memory (SRAM), Dynamic Random Access Memory (DRAM), Read-Only Memory (ROM), or Flash memory. The above-mentioned mass storage area can include any type of storage device or storage medium, such as hard disk drives, optical discs, flash drives, memory cards, and solid state disks (SSD), or any other storage device. In other words, the memory controller can access data stored in static random access memory, dynamic random access memory, flash memory, hard disk drives, and solid state drives.

The processing module of the computing apparatus can also connect and communicate with peripheral devices and interfaces including peripheral output devices, peripheral input devices, communication interfaces, or data/signal receivers through the peripheral I/O controller and the peripheral I/O bus. The peripheral input device can be any type of input device, such as a keyboard, mouse, trackball, touchpad, or joystick. The peripheral output device can be any type of output device, such as a display, or a printer; the peripheral input device and the peripheral output device can also be the same device such as a touch screen. The communication interface can include a wireless communication interface and/or a wired communication interface. The wireless communication interface can include the interface capable of supporting wireless local area networks (such as Wi-Fi, Zigbee, etc.), Bluetooth, infrared, and near-field communication (NFC), 3G/4G/5G and other mobile communication network (cellular network) or other wireless data transmission protocol; the wired communication interface can be an Ethernet device, a DSL modem, a cable modem, an asynchronous transfer mode (ATM) devices, or optical fiber communication interfaces and/or components. The data/signal receiver can include a GPS receiver or physiological signal receiver. The physiological signals received by the physiological signal receiver include, but are not limited to, heartbeat, blood oxygen levels, and so on. The processing module can periodically poll various peripheral devices and interfaces, so that the computing apparatus can input and output data through various peripheral devices and interfaces, and can also communicate with another computing apparatus having the above-mentioned hardware components.

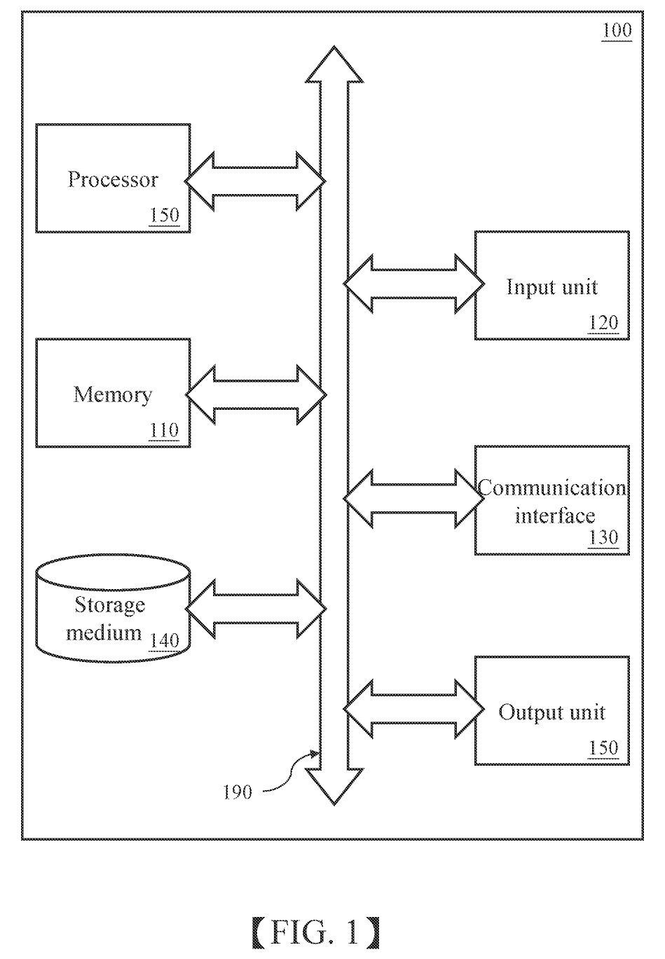

The implementation of the computing apparatus of the present invention will be explained in the following paragraphs with reference to FIG. 1, which is a schematic view of modules of a computing apparatus according to the present invention. As shown in FIG. 1, the computing apparatus 100 of the present invention includes a memory 110, an input unit 120, a communication interface 130, a storage medium 140, an output unit 150, a processor 170, and a bus 190. The processor 170 is connected to the memory 110, the input unit 120, the communication interface 130, the storage medium 140, and the output unit 150 through the bus 190.

The memory 110 stores one or more sets of computer instructions.

The input unit 120 provides input data through peripheral input devices of the computing apparatus 100. For example, the input unit 120 can input data through a keyboard, mouse, touchpad, or touch screen connected to or installed on the computing apparatus 100.

The communication interface 130 is connected to external network devices (such as network storage devices or servers) and can request to download data from the connected network devices.

The storage medium 140 stores the data or signals downloaded by the communication interface 130 and can also store the data or signals provided to or required by the processor 170 during operation, and store the data or signals generated by the processor 170.

The output unit 150 outputs the data generated by the processor 170 through peripheral output devices of the computing apparatus 100. For example, the output unit 150 can display the data generated by the processor 170 through a displayer or a touch screen connected to or installed on the computing apparatus 100.

The processor 170 executes the computer instructions stored in the memory 110 and generate each of the modules after executing the computer instructions. In another embodiment, each module in the processor 170 can be generated by one or more circuits and/or complete or partial chip hardware components, that is, the processor 170 can include hardware components that form the above-mentioned modules, so each module included in the processor 170 can be a software module or a hardware module. However, the present invention has no special limitations.

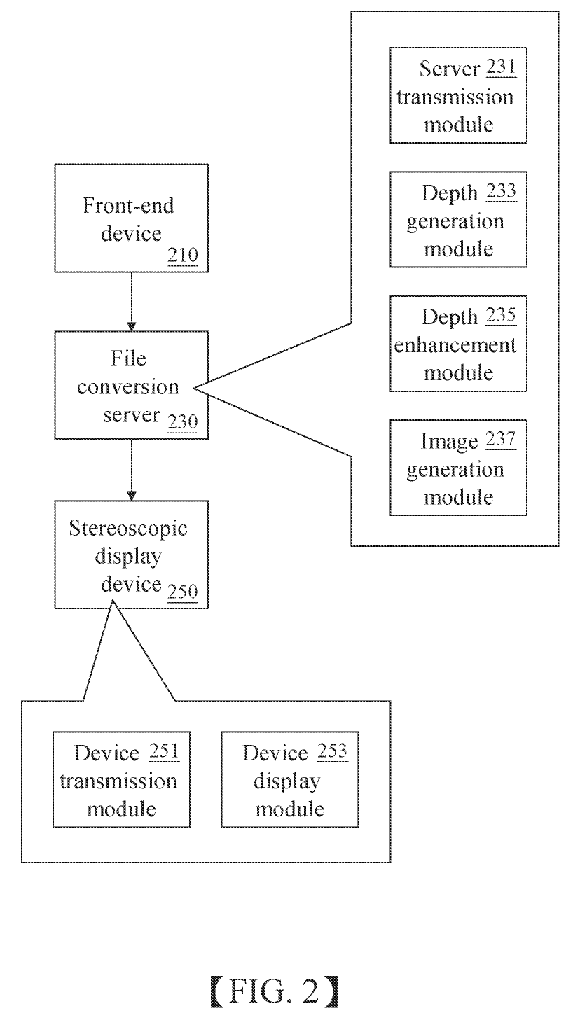

Please refer to FIG. 2. FIG. 2 shows a schematic view of components of a system of converting a 2D image into a 3D image for stereoscopic display, according to the present invention. As shown in FIG. 2, the system includes a front-end device 210, a file conversion server 230, and a stereoscopic display device 250.

The front-end device 210 is configured to select a target image. The target image selected by the front-end device 210 is a two-dimensional (2D) image, that is, a planar image. It is explained that the target image selected by the front-end device 210 is not limited to a single image and can also be multiple images.

The front-end device 210 can set a property parameter. The property parameter set by the front-end device 210 can include a resolution, a diagonal size, a width and a height, and a pixel pitch of a displayer of the stereoscopic display device 250, a range of the number of parallax images, a parallax range and a viewing distance, but the present invention is not limited to this examples. The number of parallax images is the number of views (such as 2, 4, 8, 16) provided by the stereoscopic display device. It is explained that the front-end device 210 does not necessarily set the property parameter directly, and can also set the property parameter indirectly, for example, the front-end device 210 sets the model of the stereoscopic display device 250, and can read the corresponding property parameters from the pre-stored model characteristic data based on the set model. The model property data is stored in the storage medium of the front-end device 210, and can also be stored in a network device connected to the front-end device 210, but the present invention has no special limitations.

The front-end device 210 can receive the multi-view image generated by the file conversion server 230 and provide the stereoscopic display device 250 to query and download the multi-view image generated by the file conversion server 230 corresponding to the stereoscopic display device 250.

The file conversion server 230 generates the multi-view image based on the target image selected by the front-end device 210. In an embodiment, the processor of the file conversion server 230 includes a server transmission module 231, a depth generation module 233, a depth enhancement module 235, and an image generation module 237, and can generate the multi-view image through the above modules. The above modules will be explained in the following paragraphs.

The server transmission module 231 is configured to receive the target image transmitted by the front-end device 210 through the communication interface of the file conversion server 230. In an embodiment, the server transmission module 231 transmits the file conversion completion message and the multi-view image generated by the image generation module 237 to the front-end device 210 through the communication interface of the file conversion server 230.

The depth generation module 233 uses the deep learning model to generate the depth map of the target image received by the server transmission module 231. The depth map generated by the depth generation module 233 is a grayscale image, and the value of each pixel in the depth map represents the depth of the corresponding pixel in the scene of the target image, that is, the distance between the scene corresponding to the pixel and the camera that generated the target image.

It is explained that the target image can be single image or multiple images, the deep learning model used by the depth generation module 233 to generate the depth map can also be different. For example, when the target image is single image, the deep learning model can be a combination of a transformer model and a convolutional neural network (CNN), such as Dense Prediction Transformer (DPT), or Mixed-Dataset Depth Estimation (MiDaS), or can also be a self-supervised learning model, such as Monodepth2 and other Monodepth models, or can be a Neural Radiance Fields (NeRF) model such as NeRF, Mip-NeRF, or Instant-NGP. When the target image contains multiple images, the deep learning model calculates the depth map through parallax, feature matching, and geometric reconstruction, for example, the deep learning model can be a deep learning method for multi-view depth estimation based on convolutional neural networks or transformer models, such as Multi-View Stereo Network (MVSNet), DeepMVS, or Multi-View Depth Estimation Network (MVDepthNet), or can also be a combination of Multi-View Stereo (MVS) and deep learning, or can be the above-mentioned NeRF models.

The depth enhancement module 235 performs one or more image enhancement computation on the depth map generated by the depth generation module 233 to generate the depth-enhanced image. Through the image enhancement computation, the depths of the depth map are corrected and enhanced to make the best adjustment for the stereoscopic effect in visual viewing.

The depth enhancement module 235 performs brightness extension and equalization in the image enhancement computation on the depth map, that is, performs a linear transformation on each of brightness intervals of the depth map to generate a depth-enhanced image with more stereoscopic depth details and increased image color contrast, and can also perform low-pass filtering process on the depth map to generate a smoothed depth-enhanced image, performs depth-constrained linear transformation on the depth map to generate the depth-enhanced image matching visual perception rules. It is explained that the depth enhancement module 235 can performs of one, two, or all of image enhancement computations including the above brightness extension and equalization, low-pass filtering, and depth-constrained linear transformation to generate the depth-enhanced image, and the above image enhancement computations usually have no restriction on the order of execution. For example, the depth enhancement module 235 can perform only two image enhancement computations, for example, the depth enhancement module 235 first performs brightness extension and equalization on the depth map to generate an intermediate image, and then performs low-pass filtering on the intermediate image to generate the depth-enhanced image; alternatively, the depth enhancement module 235 can first perform brightness extension and equalization or low-pass filtering on the depth map to generate an intermediate image, and then performing depth-constrained linear transformation image enhancement computation on the intermediate image to generate the depth-enhanced image.

The image generation module 237 generates the multi-view image based on the depth-enhanced image generated by the depth enhancement module 235, the multi-view image generated by the image generation module 237 contains multiple display images, each display image with different viewing angle. In most embodiments, each viewing angle of the display image is the angle between the front of the object (such as a person) in the display image and a to-be-presented direction of the object in the display image, for example, when the viewing angle of the front of the object is zero degrees and the object in the display image is presented by a right angle of 45 degrees (that is, the object in the display image is viewed from the right side of the object at 45 degrees), the viewing angle of the display image is 45 degrees.

Generally, the image generation module 237 can determine the grating film property of the stereoscopic display device 250 based on the property parameter of the stereoscopic display device 250 and generate the multi-view image based on the determined grating film property. More specifically, the image generation module 237 can calculate the number of parallax images of the stereoscopic display device 250 based on the width of the displayer and the width of a single grating unit in the grating film, to determine the grating film property of the stereoscopic display device 250. For example, the number of parallax images is a division result of the width of the displayer divided by the width of the grating unit. The image generation module 237 can calculate the disparity based on the depth map, and generates the left and right stereo pair images by shifting the pixels in the image based on the depth information and depth-based image warping, and further uses view interpolation to generate the multi-view image with the same number of display images as the number of parallax images. In an embodiment, the image generation module 237 obtains the pixel pitch of the displayer and the pitch of the grating in the grating film, and calculates the division result of the pixel pitch divided by the pitch of the grating as the number of parallax images. The pixel pitch and the pitch of the grating can be recorded in the property parameter, and the pixel pitch can also be calculated based on the resolution, the diagonal size, and the width of the displayer in the property parameter; for example, the pixel pitch can be the division result of the width of the displayer divided by the horizontal resolution of the displayer; the width of the displayer can be calculated by dividing the diagonal size of the displayer by the square root of 1 plus the square of the vertical resolution divided by the horizontal resolution.

The image generation module 237 can read the property parameter of the stereoscopic display device 250 from the storage medium of the file conversion server 230, or can obtain the property parameter of the stereoscopic display device 250 transmitted from the front-end device 210 and received by the server transmission module 231, or can connect to an external network device through the communication interface of the file conversion server 230, to download the property parameter of the stereoscopic display device 250. However, the present invention has no special limitations.

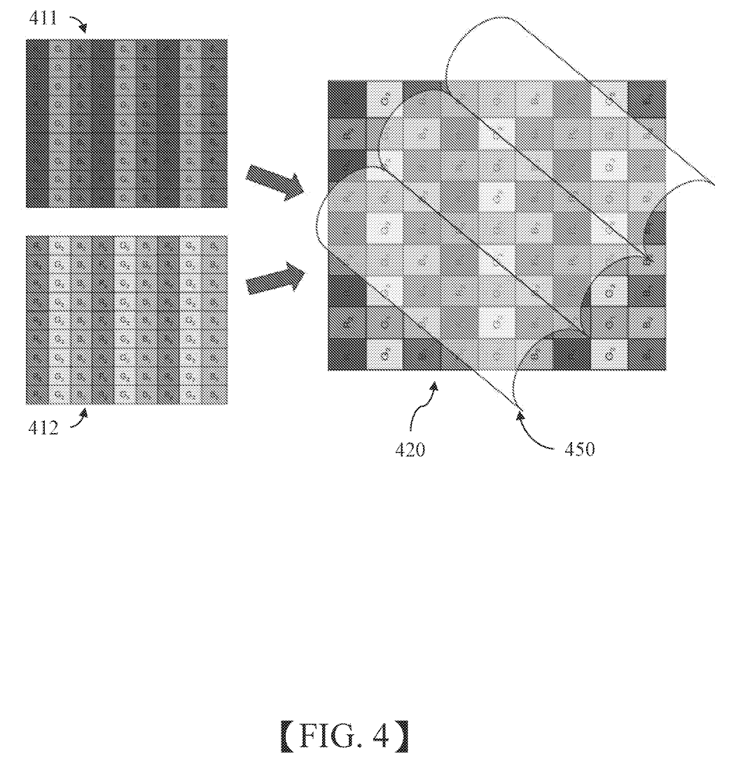

When generating the multi-view image, the image generation module 237 can interleave subpixels of each of the pixels in each of the display images to generate a multi-view image, thereby improving the clarity and 3D visual effect of the multi-view image. The subpixel usually emits a single color (R/G/B) of the three primary colors. for example, as shown in FIG. 4, when the multi-view image 420 is generated by interleaving the subpixels of two display images 411 and 412, the subpixels (R/G/B) in each pixel of the display image 411 and the subpixels (R/G/B) in each pixel of the display image 412 can be interleaved to generate the multi-view image 420, so that the multi-view image 420 presents the display image 411 and the display image 412 at different viewing angles through the grating 450, respectively.

After the multi-view image provided to the stereoscopic display device 250 is generated, the image generation module 237 can generate a file conversion completion message corresponding to the same stereoscopic display device 250. In an embodiment, the file conversion completion message generated by the image generation module 237 can include the image identification data of the generated multi-view image, and the device identification data of the stereoscopic display device 250 corresponding to the multi-view image. In an embodiment, the image identification data can be a file name, and the device identification data can be a serial number of the stereoscopic display device 250 or a serial number of a specific hardware component, but the present invention is not limited to the above examples.

The stereoscopic display device 250 displays the multi-view image generated by the file conversion server 230 in a three-dimensional manner. In an embodiment, the processor of the stereoscopic display device 250 includes a device transmission module 251 and a device display module 253.

The device transmission module 251 is configured to download the multi-view image generated by the file conversion server 230 through the communication interface of the stereoscopic display device 250. The device transmission module 251 can connect to the file conversion server 230 to download the multi-view image generated by the file conversion server 230, or can connect to the front-end device 210 to download the multi-view image stored in the front-end device 210 transmitted from the file conversion server 230, but the present invention has no special limitations.

The device display module 253 includes a grating film, and the grating film includes grating having grating units. Generally, the size of the grating film is the same as the size of the displayer or touch screen of the output unit of the stereoscopic display device, but the present invention is not limited to this examples.

The device display module 253 displays the multi-view image downloaded by the device transmission module 251, and superimposes the displayed multi-view image with the grating in the grating film, to present the corresponding display images in the multi-view image at different viewing angles through optical principles respectively, thereby creating a layered image through the visual illusion caused by the image protruding from the screen and the image receding into the screen.

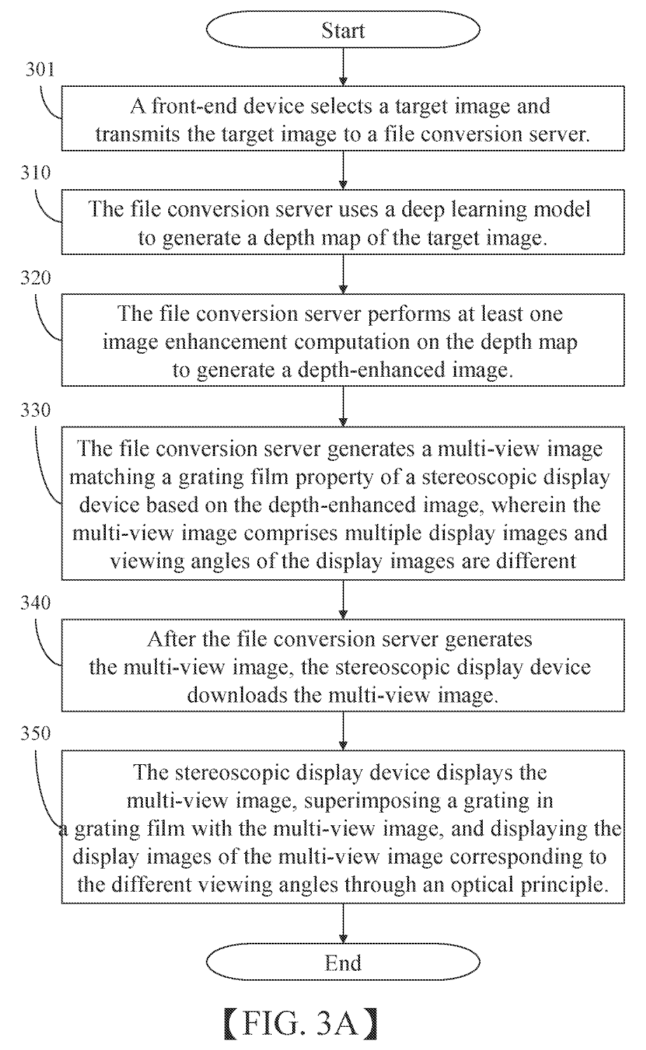

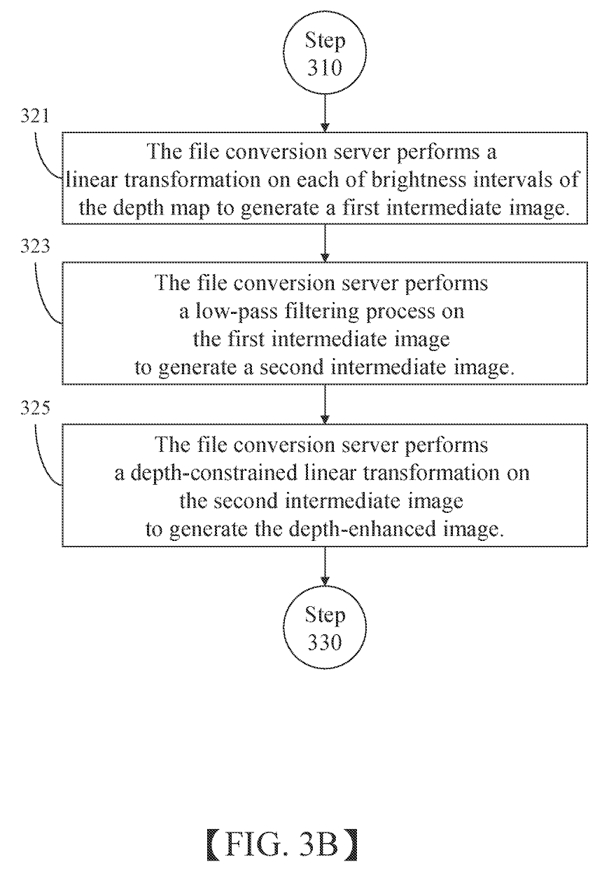

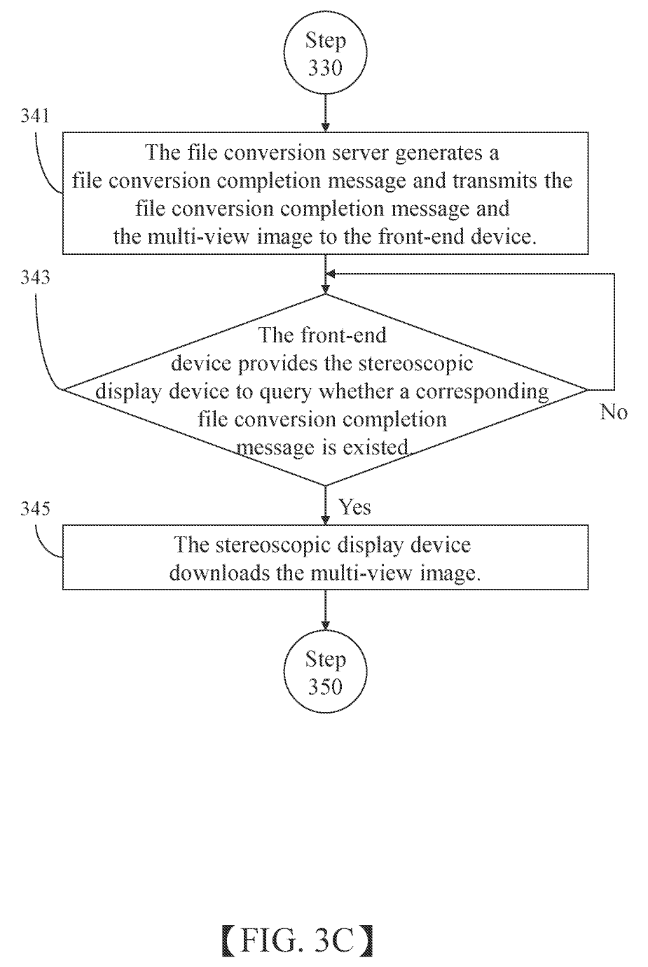

An embodiment will be explained to illustrate the operating system and method of the present invention. Please refer to FIG. 3A, which is a flowchart of a method of converting a 2D image to a 3D image for stereoscopic display, according to the present invention.

In a step 301, a front-end device 210 selects a 2D target image, and the selected target image is transmitted to the file conversion server 230.

In a step 310, after the server transmission module 231 of the file conversion server 230 receives the target image transmitted from the front-end device 210, the depth generation module 233 of the file conversion server 230 uses the deep learning model to generate the depth map of the target image received by the server transmission module 231. In this embodiment, the deep learning model used by the file conversion server to generate the depth map can be the machine learning model for depth estimation disclosed in the paper "Towards Robust Monocular Depth Estimation: Mixing Datasets for Zero-shot Cross-dataset Transfer" published in IEEE Transactions on Pattern Analysis and Machine Intelligence (Volume:44, Issue:3) on March 1, 2022.

In a step 320, after the depth generation module 233 of the file conversion server 230 generates the depth map, the depth enhancement module 235 of the file conversion server 230 performs image enhancement computation on the depth map generated by the depth generation module 233 to generate a depth-enhanced image. In this embodiment, as shown in the flowchart of FIG. 3B, it is assumed that the depth enhancement module 235 first performs brightness extension and equalization in image enhancement computations on the depth map to generate a first intermediate image with more stereoscopic depth details, and increases the color contrast of the image in a step 321, and then performs low-pass filtering process on the first intermediate image to generate a smoothed second intermediate image in a step 323, and can perform depth-constrained linear transformation on the second intermediate image to generate a depth-enhanced image matching visual perception rules in a step 325.

In a step 330, after the depth enhancement module 235 of the file conversion server 230 generates the depth-enhanced image, the image generation module 237 of the file conversion server 230, generates the multi-view image, which contains display images with different viewing angles and matches the grating film property of the stereoscopic display device 250, based on the depth-enhanced image generated by the depth enhancement module 235. In this embodiment, it is assumed that the image generation module 237 reads the property parameter of the stereoscopic display device 250 from the storage medium of the file conversion server 230, and determines the grating film property of the stereoscopic display device 250 based on the read property parameter; next, the image generation module 237 uses the depth-enhanced image to generate the multi-view image that matches the grating film property of the stereoscopic display device 250, for example, the image generation module 237 can generate the display images having different viewing angles with the same number as the number of parallax images in the grating film property, and can interleave subpixels of each pixel in each display image to generate the multi-view image with interleaved subpixels.

In a step 340, after the file conversion server 230 generates the multi-view image, the device transmission module 251 of the stereoscopic display device 250 downloads the multi-view image generated by the file conversion server 230. In this embodiment, as shown in the flowchart of FIG. 3C, it is assumed that the image generation module 237 of the file conversion server 230 can generates the file conversion completion message after generating the multi-view image, the server transmission module 231 of the file conversion server 230 can transmit the file conversion completion message and the multi-view image to the front-end device 210 for storage in a step 341, and the front-end device 210 can provide the device transmission module 251 of the stereoscopic display device 250 to query whether there is a corresponding file conversion completion message in a step 343; if there is a corresponding file conversion completion message, the device transmission module 251 downloads the multi-view image generated by the file conversion server 230 in a step 345.

After the device transmission module 251 of the stereoscopic display device 250 downloads the multi-view image generated by the file conversion server 230, the device display module 253 of the stereoscopic display device 250 displays the multi-view image, superimposes the grating in the grating film with the displayed multi-view image, and presents the display images in the multi-view image at different viewing angle through optical principle, respectively, in a step 350.

With the technical solution of the present invention, a 2D image can be converted into the multi-view image for stereoscopic display, and a 3D stereoscopic image can be displayed by superimposing the multi-view image with the grating film.

According to above-mentioned contents, the difference between the present invention and the conventional technology in that, in the present invention, the file conversion server performs the image enhancement computation on the depth map of the 2D target image to generate the depth-enhanced image, and generates the multi-view image matching the grating film property of the stereoscopic display device based on the depth-enhanced image, the stereoscopic display device downloads and displays the multi-view image, and superimposes the grating with the multi-view image and displays the display images in the multi-view image at different viewing angles to generate the stereoscopic image through optical principles, thereby solving the conventional problem of insufficient quality of three-dimensional display using the multi-view image generated by depth image generation technology, and achieving the technical effect of displaying the stereoscopic image with high comfort and high resolution.

Furthermore, the method of converting a 2D image to a 3D image for stereoscopic display of the present invention can be implemented by hardware, software or a combination thereof, and can be implemented in a computer system by a centralization manner, or by a distribution manner of different components distributed in several interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of converting a 2D image to a 3D image for stereoscopic display, and the method comprising:
selecting a target image and transmitting the target image to a file conversion server, by a front-end device, wherein the target image is a two-dimensional (2D) image;
using a deep learning model to generate a depth map of the target image, by the file conversion server;
performing at least one image enhancement computation on the depth map to generate a depth-enhanced image, by the file conversion server;
generating a multi-view image matching a grating film property of a stereoscopic display device based on the depth-enhanced image, by the file conversion server, wherein the multi-view image comprises display images and viewing angles of the display images are different from each other;
after the file conversion server generates the multi-view image, downloading the multi-view image, by the stereoscopic display device; and
displaying the multi-view image, superimposing a grating in a grating film with the multi-view image, and displaying the display images of the multi-view image corresponding to the different viewing angles through optical principles, by the stereoscopic display device.

2. The method of converting a 2D image to a 3D image for stereoscopic display according to claim 1, after the step of performing the at least one image enhancement computation on the depth map to generate the depth-enhanced image by the file conversion server, further comprising:
performing a linear transformation on each of brightness intervals of the depth map to generate a first intermediate image, performing a low-pass filtering process on the first intermediate image to generate a second intermediate image, and performing a depth-constrained linear transformation on the second intermediate image to generate the depth-enhanced image, by the file conversion server.

3. The method of converting a 2D image to a 3D image for stereoscopic display according to claim 1, wherein the step of downloading the multi-view image by the stereoscopic display device after the file conversion server generates the multi-view image, comprises:
generating a file conversion completion message corresponding to the stereoscopic display device and transmitting the file conversion completion message and the multi-view image to the front-end device after receiving the file conversion completion message, by the file conversion server, and providing the stereoscopic display device to download the multi-view image by the front-end device.

4. The method of converting a 2D image to a 3D image for stereoscopic display according to claim 1, wherein the step of generating the multi-view image matching the grating film property of the stereoscopic display device based on the depth-enhanced image by the file conversion server, comprises:
determining the grating film property based on a property parameter transmitted by the front-end device, and using the depth-enhanced image to generate the multi-view image matching the grating film property, by the file conversion server, wherein the grating film property comprises the number of parallax images.

5. The method of converting a 2D image to a 3D image for stereoscopic display according to claim 1, wherein the step of generating the multi-view image matching the grating film property of the stereoscopic display device based on the depth-enhanced image by the file conversion server, comprises:
interleaving subpixels of each of pixels in each of the display images to generate the multi-view image, by the file conversion server.

6. A system of converting a 2D image to a 3D image for stereoscopic display, comprising:
a front-end device, configured to select a target image, wherein the target image is a two-dimensional image;
a file conversion server, configured to receive the target image transmitted by the front-end device, use a deep learning model to generate a depth map of the target image, and perform at least one image enhancement computation on the depth map to generate a depth-enhanced image, and generate a multi-view image matching a grating film based on the depth-enhanced image, wherein the multi-view image comprises display images, and viewing angles of the display images are different from each other; and
a stereoscopic display device, comprising a grating film having a grating, and the grating comprises multiple grating units, wherein the stereoscopic display device is configured to download the multi-view image generated by the file conversion server, and display the multi-view image, superimpose the grating with the multi-view image, and display the display images of the multi-view image corresponding to the different viewing angles through optical principle.

7. The system of converting a 2D image to a 3D image for stereoscopic display according to claim 6, wherein the file conversion server performs a linear transformation on each of brightness intervals of the depth map to generate a first intermediate image, performs a low-pass filtering process on the first intermediate image to generate a second intermediate image, and performs a depth-constrained linear transformation on the second intermediate image to generate a depth-enhanced image.

8. The system of converting a 2D image to a 3D image for stereoscopic display according to claim 6, wherein after generating the multi-view image, the file conversion server generates a file conversion completion message corresponding to the stereoscopic display device, and transmits the file conversion completion message and the multi-view image to the front-end device, and after the front-end device receives the file conversion completion message, the front-end device provides the stereoscopic display device to download the multi-view image.

9. The system of converting a 2D image to a 3D image for stereoscopic display according to claim 6, wherein the front-end device transmits a property parameter of the stereoscopic display device to the file conversion server, the file conversion server determines the grating film property based on the property parameter and uses the depth-enhanced image to generate the multi-view image matching the grating film property, wherein the grating film property comprises the number of parallax images.

10. The system of converting a 2D image to a 3D image for stereoscopic display according to claim 6, wherein the file conversion server further interleaves subpixels of each of pixels in each of the display images to generate a multi-view image.
